(19) United States
(12) Patent Application Publication
(10) Pub. No.: US 2026/0153411 A1
(43) Pub. Date: Jun. 4, 2026

(54) BEARING UNIT WITH A COATING UNIT FOR A TIRE TEST STAND, METHOD FOR MANUFACTURING A BEARING UNIT AND TIRE TEST STAND WITH A BEARING UNIT

(71) Applicant: ZF Friedrichshafen AG, Friedrichshafen (DE)

(72) Inventors: Roland BÖSL, Neuburg am Inn (DE); Alexander BOEHM, Ruderting (DE)

(73) Assignee: ZF Friedrichshafen AG, Friedrichshafen (DE)

(21) Appl. No.: 19/404,582

(22) Filed: Dec. 1, 2025

(30) Foreign Application Priority Data
Dec. 2, 2024 (DE) 10 2024 211 492.8

(51) Int. Cl. G01M 17/02

(52) U.S. Cl. CPC G01M 17/021

(57) ABSTRACT

A bearing unit for a tire test stand has a carrier unit and a coating unit. The carrier unit has an inlet section defining an inlet opening and a plurality of outlet sections. Each outlet section defines an outlet opening, where each outlet opening is connected to the inlet opening so that when a pressurized gaseous fluid flows into the inlet opening the pressurized gaseous fluid flows out of each outlet opening. The coating unit has a plurality of passage sections each defining a passage opening. The carrier unit and the coating unit are arranged so that for each outlet opening, the outlet opening and an associated passage opening are arranged so that when pressurized gaseous fluid flows out of the outlet opening, the gaseous fluid flows through the associated passage opening. A method and a tire test stand are shown and described.

### RELATED APPLICATIONS

This application claims the benefit of and right of priority under 35 U.S.C. § 119 to German Patent Application no. 10 2024 211 492.8, filed on 2 Dec. 2024, the contents of which are incorporated herein by reference in its entirety.

### FIELD OF THE DISCLOSURE

The present invention relates to a bearing unit for a tire test stand, a method for producing a bearing unit, and a tire test stand with a bearing unit.

### BACKGROUND

Tire test stands are known from the prior art. These tire test stands usually comprise a frame and a tire holder. A tire with a tread surface can be fitted onto the tire holder so that it can rotate about its rotation axis. When the tire is fitted rotatably on the tire holder, the tire can be moved to various positions relative to the frame. In the tire test stands known from the prior art a rolling surface unit with a rolling surface is provided, which can be moved relative to the frame. The rolling surface of the rolling surface unit can also be called a road simulation and is provided in order to simulate the behavior on a road, to a close approximation.

### SUMMARY

In general, it is desirable for the testing of tires to be carried out particularly reliably.

Accordingly, the purpose of the present invention is to provide a bearing unit for a tire test stand, such that tires can be tested particularly reliably.

According to a first aspect of the invention, the objective is achieved by a bearing unit having features disclosed herein. The bearing unit is designed for a tire test stand. The bearing unit comprises a carrier unit and a coating unit. The carrier unit has an inlet section that defines an inlet opening, and a plurality of outlet sections. Each outlet section of the plurality of outlet sections defines an outlet opening. Each outlet opening is connected to the inlet opening in such manner that when a pressurized gaseous fluid flows into the inlet opening, the pressurized gaseous fluid flows out of each outlet opening. The coating unit has a plurality of passage sections. Each passage section defines a passage opening. The carrier unit and the coating unit are arranged relative to one another in such manner that when the pressurized gaseous fluid flows out of the corresponding outlet opening, the gaseous fluid emerging from the corresponding outlet opening flows into and through the associated passage opening.

As already described, the bearing unit is designed for a tire test stand. Preferably, the bearing unit comprises a fixing section by means of which the bearing unit can be attached to a fixing section of the tire test stand. Preferably, the fixing section of the bearing unit can be attached to a fixing section of a frame of the tire test stand.

As also already described, the bearing unit comprises a carrier unit and a coating unit. The carrier unit can also be called the carrier. Preferably, the carrier unit comprises the fixing section by which the bearing unit can be attached to the fixing section of the tire test stand. In the alternative, preferably, the carrier unit is connected to the fixing section by which the bearing unit can be attached to the fixing section of the tire test stand. The coating unit can also be called the coater or the anti-friction coater. Preferably the coating unit has a surface facing in the direction toward the surroundings of the bearing unit. In particular, the coating unit can be configured independently of the carrier unit and can, for example, be adjusted so that the surface of the coating unit has a low coefficient of friction but high abrasion resistance and high temperature resistance, particularly in the case when the surface of the coating unit comes into contact with a surface of a flat belt section of a belt unit of the tire test stand.

As also already described, the carrier unit has an inlet section which defines an inlet opening, and a plurality of outlet sections, such that each outlet section of the plurality of outlet sections defines an output opening. As also already described, each outlet opening is connected to the inlet opening in such manner that when a pressurized gaseous fluid flows into the inlet opening, the pressurized gaseous fluid flows out of each outlet opening. Since the carrier unit comprises the inlet section which defines the inlet opening and the plurality of outlet sections, wherein each outlet section of the plurality of outlet sections defines an outlet opening and each outlet opening is connected to the inlet opening in such manner that when a pressurized gaseous fluid flows into the inlet opening, the pressurized gaseous fluid flows out of every outlet opening, it is ensured that with the help of the bearing unit in the area of the outlet openings a bearing for guiding the belt unit of the tire test stand can be provided, specifically since with the help of the gaseous fluid flowing out of every outlet opening a force can be exerted on the flat belt section, which force acts in a direction from the bearing unit toward the flat belt section and in the direction of a tire in contact with the flat belt section.

As also already described, the carrier unit and the coating unit are arranged relative to one another in such manner that in the case of every outlet opening, the outlet opening concerned and a passage opening associated with the outlet opening concerned are arranged relative to one another so that when the gaseous fluid flows out of the corresponding outlet opening, it flows through the passage opening associated with the outlet opening. Since the carrier unit and the coating unit are arranged relative to one another in such a way that in the case of each outlet opening the outlet opening concerned and a passage opening associated with the outlet opening concerned are arranged relative to one another so that when the pressurized gaseous fluid flows out of the outlet opening, the gaseous fluid flowing out of the outlet opening flows through the passage opening associated with the outlet opening concerned, it is ensured that the bearing unit can be arranged so that the coating unit can be positioned on a side of the carrier unit facing toward the flat belt section, and with that arrangement, by virtue of the outlet opening, the passage openings and the gaseous fluid, as well as with the help of the coating unit, a bearing for guiding the belt unit can be provided. In this case the bearing unit fulfills two functions, so that the bearing unit can also be called a hybrid bearing unit. A first function of the two functions is provided with the help of the outlet openings, the passage openings and the gaseous fluid, in that in the area of the outlet openings and the passage openings a bearing for guiding the belt unit is provided, since with the help of the gaseous fluid flowing out of each outlet opening, a force can be produced on the side of the flat belt section on which the bearing unit is arranged, which force acts in a direction toward a side of the flat belt section opposite the side of the flat belt section, so that a deformation of the flat belt section in a direction toward the side of the flat belt section on which the bearing unit is located can be reduced or even prevented completely. Now, when a load on the flat belt section is imposed by various loading conditions of a tire fitted onto the tire holder of the test stand, which load is large enough for the flat section to be deformed sufficiently for it to come into contact with the bearing unit, then for that contact the coating unit is provided, which, independently of the structure of the carrier unit can be designed for contact with the flat belt section and which has a surface designed for that contact. A second function of the two functions is provided with the help of the coating unit, in that in addition, with the help of the coating unit, a bearing for guiding the belt unit is provided since by virtue of the coating unit the surface, which can also be called the contact surface, is provided for contact with the flat belt section, so that an additional force acting on the flat belt section can be produced, which acts upon the side of the flat belt section on which the bearing unit is arranged, in a direction toward the flat belt section.

Since with the help of the pressurized gaseous fluid, and by virtue of the coating unit, the bearing unit can fulfill a double function, with the bearing unit particularly large forces can act upon the flat belt section, so that with the help of the bearing unit tire test stands in the high-load range, in particular with wheel loads of more than one tonne (wheel loads>1 t) can be operated and thereby water bearings can be dispensed with. Water bearings often use water for the bearing of the flat belt section. Water bearings often have a metallic body with which, by way of a larger number of small holes, water under pressure emerges from the surface and thus makes its way between a belt unit, specifically a flat belt section of the belt unit of the tire test stand, and the surface. This pressurized water and the resulting water film between the belt unit and the surface described supports the flat belt surface while it moves past the surface, sometimes at high speed. During this, the water used is often captured and drained away and should not get between the belt unit and the deflection rollers of the tire test stand because there the necessary friction is reduced and in an extreme case the bearing regulation of the belt unit fails. But when the water gets between the belt unit and the deflection rollers of the tire test stand, the belt unit can no longer transfer the traction, and lateral forces of the tire to the deflection rollers. Furthermore, if water gets between the belt unit and the tire (splashed water, water mist), then the measured values determined at the tire are falsified (the friction between the tire and the belt unit is altered). Usually, rotating wipers are fitted to a water bearing. These attempt to sweep away the complete water film and splashed water in a controlled manner. A further weakness is the risk that the deflectors of tire particles adhering to the underside of the belt unit will be damaged. After intensive tests the deflectors often have to be replaced. Thus, compared with water bearings, the bearing according to the invention ensures more reliable testing of tires with a simpler structure that requires less maintenance.

Compared with counter-bearings as well, which use the medium air and can also be called air bearings, the bearing unit according to the invention has advantages. With air bearings, often air under high pressure (30 bar) is forced between the two components bearing upon one another. Industrially common air bearings work without contact. During operation, if any contact takes place while moving, this results in damage to the contact surfaces. Provided, however, that it can be assumed that the two components keep their shape sufficiently exactly, a direct contact can be avoided. A contact between two conventionally produced partners results in higher friction and, in combination with high speeds, to high friction work and therefore high temperatures that damage the surfaces. With wheel loads in excess of one tonne and the lateral forces that can be produced thereby, substantial elastic deformations of the belt unit can take place, in particular the flat belt section. In particular, current tire designs produce high peak pressures under certain operating conditions. As a result of these, the belt unit can even undergo local deformations so that the components of the air bearing touch one another. In such cases the essential freedom from contact is no longer feasible. Accordingly, there is a preconception that air bearings can only be used in the load range up to one tonne, with certain types of tires and only when the lateral forces are very limited. Compared with air bearings, the bearing unit according to the present invention therefore ensures that tire test stands can be operated reliably even in load ranges higher than one tonne.

With the bearing unit according to the invention, thanks to the coating unit a contact between the bearing unit and the belt unit, in particular the flat belt section, can deliberately be allowed. In tests carried out on the bearing unit according to the invention, it could be established that even under extreme operating conditions in relation to load, air pressure in the tires and lateral forces due to steering, it is still the case that over 95% of the load is supported by the pressurized gaseous fluid. In particular, with the help of the bearing unit according to the invention damage to the carrier unit can advantageously be prevented, especially by comparison with air bearings in which only a carrier unit but no coating unit is provided. In particular, with the help of the coating unit a suitable coating can be provided, whose surface has a low coefficient of friction along with high abrasion resistance and temperature resistance so that the remaining 5% of the load can be taken up by these local contacts. In that way, all the usual tire types can be tested with high wheel loads. In case of wear, a simpler, quicker, and less costly replacement is possible. It is not the air bearing itself that is exposed to wear, but only the coating unit.

In summary, it can thus be established that with the help of the present invention tires can be tested particularly reliably.

In an embodiment, the carrier unit and the coating unit are connected to one another. Since the carrier unit and the coating unit are connected to one another, a particularly simply constructed bearing unit is obtained, which can be made in a particularly weight-saving manner since in particular a plate unit can be dispensed with. Preferably, the carrier unit and the coating unit are connected to one another in that the carrier unit is coated with the coating unit. Preferably, in that way the coating unit forms a layer with which the carrier unit is coated.

In an embodiment, a plate unit is arranged between the carrier unit and the coating unit, such that the plate unit and the coating unit are connected to one another. Since a plate unit is arranged between the carrier unit and the coating unit, wherein the plate unit and the coating unit are connected to one another, it is ensured that the plate unit can be replaced together with the coating unit, in particular without having to replace or machine the carrier unit. Preferably, the plate unit is connected to the carrier unit on a first side of the plate unit and is connected to the coating unit on a second side of the plate unit opposite the first side. Now, when the coating unit has to be renewed, the carrier unit and the plate unit can be separated from one another and the plate unit, together with the coating unit, can be removed and a new plate unit, which is also connected to a coating unit, can be connected to the carrier unit. Since the plate unit is arranged between the carrier unit and the coating unit whereas the plate unit and the coating unit are connected to one another, the replacement of the coating unit is considerably simplified. Preferably, the plate unit and the coating unit are connected to one another in that the plate unit is coated by the coating unit. Preferably, the coating unit thus forms a layer with which the plate unit is coated.

In an embodiment the carrier unit comprises a metal or a metal alloy. Since the carrier unit comprises a metal or metal alloy, it is ensured that a mechanically particularly robust carrier unit is obtained. Preferably the carrier unit is made of a metal or metal alloy, so that the carrier unit can be made mechanically particularly robust. Preferably the carrier unit is made of steel so that the mechanical robustness of the carrier unit is ensured in a particularly optimal manner. Preferably the carrier unit is made of aluminum so that the carrier unit is made particularly weight-saving.

In an embodiment, the coating unit comprises a metal or a metal alloy. Since the coating unit comprises a metal or metal alloy, the coating unit provides a surface for contact with the belt unit, in particular with the flat belt section, such that the surface has high abrasion resistance and high temperature resistance. Preferably, the coating unit consists of stainless steel so that a surface with particularly high abrasion resistance can be obtained.

In an embodiment, the coating unit comprises a polymer. Since the coating unit comprises a polymer, a surface with a particularly low coefficient of friction can be obtained. Preferably the coating unit comprises a fluorpolymer. Since the coating unit comprises the fluorpolymer, a particularly low coefficient of friction is obtained. Preferably, the coating unit comprises stainless steel and a fluorpolymer. Since the coating unit comprises stainless steel and a fluorpolymer, the coating unit can provide a surface for contact with the belt unit, in particular with the flat belt section, such that the surface has a low coefficient of friction with high abrasion resistance and high temperature resistance. Preferably, the fluorpolymer is polytetrafluorethylene (PTFE), so that a very particularly low coefficient of friction can be obtained.

According to a second aspect of the invention, the stated objective is achieved by a method as disclosed herein. The method is provided for producing a bearing unit according to the first aspect of the invention. The method comprises the following steps: preparation of the carrier unit and the coating unit in such a way that the carrier unit and the coating unit are arranged relative to one another so that for each outlet opening, the outlet opening concerned and a passage opening associated with the outlet opening concerned are arranged relative to one another in such manner that when the pressurized gaseous fluid flows out of the outlet opening, the gaseous fluid flowing out of the outlet opening flows through the passage opening associated with the outlet opening. Since the carrier unit and the coating unit are arranged relative to one another so that for each outlet opening the outlet opening concerned and a passage opening associated with the outlet opening are arranged relative to one another in such manner that when the pressurized gaseous fluid flows out of the outlet opening concerned, the gaseous fluid flowing out of the outlet opening flows through the passage opening associated with the outlet opening, it is ensured that the bearing unit can be can be arranged so that the coating unit can be arranged on a side of the carrier unit that faces toward the flat belt section and with this arrangement, by virtue of the outlet openings, the passage openings and the gaseous fluid as well as with the help of the coating unit, a bearing for guiding the belt unit can be provided. In that case, the bearing unit carries out the two functions already described.

In an embodiment, a surface of the carrier unit or a surface of the plate unit is roughened, and metal particles or metal alloy particles are sprayed onto the roughened surface of the carrier unit or onto the roughened surface of the plate unit, and a polymer layer can then be applied over the sprayed-on metal particles. Since the surface of the carrier unit or the surface of the plate unit are roughened, it is ensured that between the surface of the carrier unit and the sprayed-on metal particles or between the surface of the plate unit and the sprayed-on metal particles a mechanically particularly robust connection can be formed. Since the polymer layer is applied over the sprayed-on metal particles, it is ensured that a surface with a particularly low coefficient of friction can be produced.

The features, technical effects and/or advantages described in connection with the bearing unit according to the first aspect of the invention also apply, at least analogously, to the method according to the second aspect of the invention, so that no corresponding repetitions will be made at this point. Even though the steps of the method have been described in a particular sequence, the invention is not limited to that sequence. Rather, the individual method steps can be carried out in any rational sequence, in particular also parallel with one another in time, at least in part.

According to a third aspect of the invention, the stated objective is achieved by a tire test stand having the features disclosed herein. The tire test stand has a frame. In addition, the tire test stand has a tire holder attached to the frame onto which a tire with a tread surface can be fitted so as to rotate about its rotation axis. Furthermore, the tire test stand has a belt unit. Moreover, the tire test stand comprises two deflection rollers mounted to rotate relative to the frame. The deflection rollers are partially wrapped around by the belt unit in such manner that the belt unit forms a flat belt section between the deflection rollers. When the tire is fitted rotatably onto the tire holder, the tire can be brought into a contact position against a first side of the flat belt section, in which position the tread of the tire and the flat belt section are in contact. When the tire and the flat belt section are in contact and the belt unit is moved relative to the tire, the tire rolls on the flat belt section. The tire test stand also comprises a bearing unit according to the first aspect of the invention. The bearing unit is arranged on a second side of the flat belt section opposite the first side thereof, in such manner that the coating unit is arranged on a side of the carrier unit facing toward the flat belt section. Each deflecting roller can also be called a drum. Since the bearing unit is arranged on the second side of the flat belt section, the bearing unit can oppose the deformation of the flat belt section in the direction toward the second side of the flat belt section or even prevent any deformation of the flat belt section in the direction toward the second side of the flat belt section. Since the bearing unit is arranged on the second side of the flat belt section opposite the first side in such a way that the coating unit is arranged on the side of the carrier unit facing toward the flat belt section, it is ensured that the coating unit is provided for contact with the flat belt section and the coating unit protects the carrier unit against contact with the flat belt section. Accordingly, the coating unit can be designed specifically for contact with the flat belt section and if the coating unit has suffered wear, the coating unit can be renewed or replaced and the carrier unit can continue being used, whereby a particularly resource-sparing bearing unit and a particularly resource-sparing tire test stand can be provided.

In an embodiment, the belt unit comprises a metal or a metal alloy. Since the belt unit comprises a metal or metal alloy, it is ensured that the belt unit is constructed particularly mechanically robustly. Preferably the belt unit is made of steel, whereby it is ensured that under various load conditions of the tire the belt unit will be deformed only very slightly, so that with the help of the tire test stand tires can be mechanically loaded particularly severely. If the belt unit is made of steel, the belt unit can also be called the steel band.

The features, technical effects, and/or advantages described in connection with the bearing unit according to the first aspect of the invention, and the features, technical effects and/or advantages described in connection with the method according to the second aspect of the invention also apply, at least by analogy, to the tire test stand according to the third aspect of the invention, so no repetitions will be made at this point.

It has emerged that with the help of the bearing unit, according to the first aspect of the present invention, the following advantages can be achieved compared with water bearings as known from the prior art: with the help of the bearing unit according to the first aspect of the present invention, there is no need for wipers (including conditioning, adjustment, replacement, etc.). With the help of the bearing unit according to the first aspect of the present invention, the risk of falsifying the measurements due to splashed water is avoided. With the help of the bearing unit according to the first aspect of the present invention the risk of failure of the belt unit regulation resulting from friction loss between the belt unit and the deflection rollers is avoided. With the help of the bearing unit according to the first aspect of the present invention the risk of components of the bearing unit becoming corroded and the risk of components of the tire test stand becoming corroded is substantially reduced. With the help of the bearing unit according to the first aspect of the present invention the risk that tire particles may be mixed with water (soiling of the plant) is avoided. With the help of the bearing unit according to the first aspect of the present invention, no changing of used water (due to unpleasant smells) is necessary. With the help of the bearing unit according to the first aspect of the present invention, no pressurized water unit is needed.

It has emerged that with the help of the bearing unit according to the first aspect of the present invention, the following advantages can be achieved compared with air bearings as known from the prior art: with the help of the bearing unit according to the first aspect of the present invention high wheel forces and lateral forces can be safely managed. With the help of the bearing unit according to the first aspect of the present invention the costs for coating or of the coated plates are low. With the help of the bearing unit according to the first aspect of the present invention, much quicker and simpler replacement of the coated plates and therefore a short idle time of the equipment is ensured. With the help of the bearing unit according to the first aspect of the present invention, a very short idle time of the equipment in the event of damage and for maintenance purposes is ensured.

### BRIEF DESCRIPTION OF THE DRAWINGS

Further features, advantages, and application options of the present invention emerge from the following description of example embodiments and from the figures. In this context, all the features described and/or illustrated pictorially, in their own right and in any combination, constitute the object of the invention, even independently of their composition in the individual claims or their back-references. Furthermore, in the figures the same indexes denote the same or similar objects. The figures show:

FIG. 1: A schematic representation of an embodiment of a tire test stand according to the invention,

FIG. 2: A schematic representation of an embodiment of a bearing unit according to the invention, and

FIG. 3: A schematic representation of an embodiment of a method according to the invention for producing the embodiment of the bearing unit according to the invention shown schematically in FIG. 2.

### DETAILED DESCRIPTION

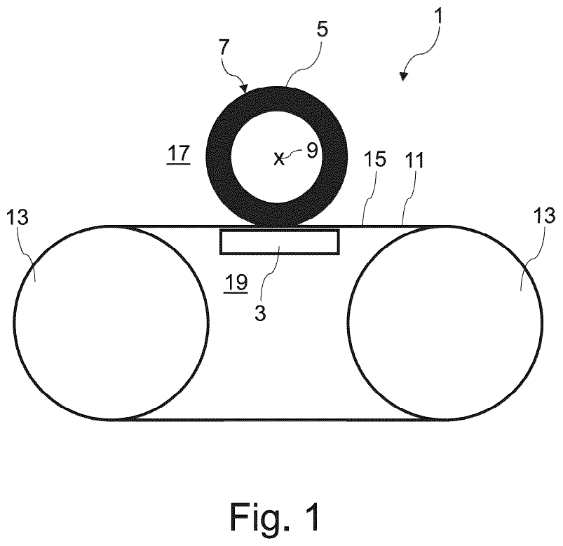

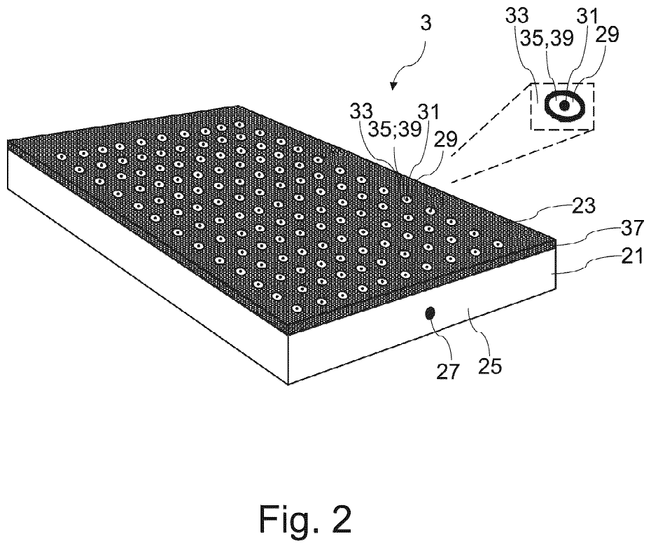

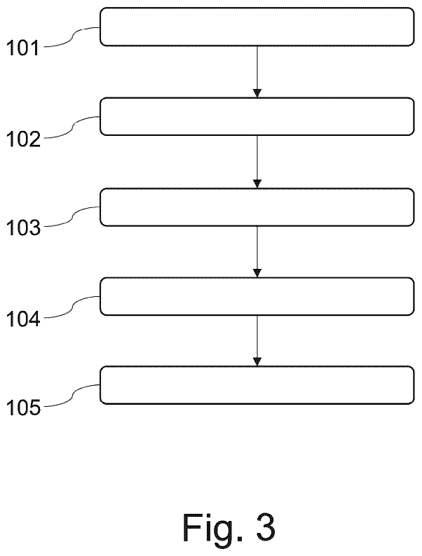

FIG. 1 shows a schematic representation of an embodiment of a tire test stand 1 according to the invention, FIG. 2 shows a schematic representation of an embodiment of a bearing unit 3 according to the invention, and FIG. 3 shows a schematic representation of an embodiment of a method according to the invention for producing the embodiment of the bearing unit 3 according to the invention shown schematically in FIG. 2.

The tire test stand 1 comprises a frame (not shown). In addition, the tire test stand 1 comprises a tire holder attached to the frame (also not shown). A tire 5 with a tread surface 7 can be fitted onto the tire holder so that it can rotate about its rotation axis 9. Furthermore, the tire test stand 1 comprises a belt unit 11. Moreover, the tire test stand 1 comprises two deflection rollers mounted rotatably relative to the frame. Each deflection roller 13 of the deflection rollers is partially wrapped round by the belt unit 11. Thus, the deflection rollers are partially wrapped around by the belt unit 11. The deflection rollers are partially wrapped around by the belt unit 11 in such manner that between the deflection rollers the belt unit 11 forms a flat belt section 15. When the tire 5 is fitted rotatably on the tire holder, the tire can be brought to a contact position with a first side 17 of the flat belt section 15, as shown in FIG. 1 in which the tread surface 7 of the tire 5 and the flat belt section 15 are in contact. The tire test stand 1 comprises a belt drive unit (not shown). The belt drive unit can drive the belt unit 11 in a belt rotation direction. The belt drive unit is coupled with one deflection roller 13 of the deflection rollers, in order to drive the belt unit 11 in the belt rotation direction by means of the deflection roller 13. Now, when the tire 5 and the flat belt section 15 are in contact and the belt unit 11 moves relative to the tire 5, the tire 5 rolls on the flat belt section 15. The tire test stand 1 also comprises the bearing unit 3. The bearing unit 3 is arranged on a second side 19 of the flat belt section 15 opposite the first side 17.

The tire 5 can be positioned relative to the flat belt section 15. In particular, by adjusting a drive element or by adjusting a plurality of drive elements the tire 5 can be brought to the contact position in which the tread surface 7 of the tire 5 is in contact with the flat belt section 15. Furthermore, by adjusting a drive element or by adjusting a plurality of drive elements, besides the contact position the tire 5 can be brought to further contact positions in which the tread 7 of the tire 5 is likewise in contact with the flat belt section 15. If now the tire 5 rolls on the flat belt section 15, the tire 5 can be subjected to various load conditions. By adjusting the drive element or the plurality of drive elements, when the tire 5 is rolling on the flat belt section 15 the camber of the tire 5, the skew of the tire 5, the tire load of the tire 5, and/or the position of the tire 5 relative to the flat belt section 15 can be adjusted. Furthermore, with the help of a tire drive unit of the tire test stand 1, the tire 5 can be driven in a tire rotation direction or, with the help of a tire braking unit, it can be braked in the tire rotation direction. In that way, when rolling, the tire 5 can be brought to various load conditions. In each load condition of the tire 5 different reaction forces act upon the tire 5, which can be detected with the help of a detection unit of the tire test stand 1. Since the tire 5 rolls on the flat belt section 15, it is ensured that a situation in which the tire 5 is rolling on a real road can be simulated particularly well. In every load condition of the tire 5, not only reaction forces act upon the tire 5. Rather, in the various load conditions, forces also act upon the belt unit 11 and in particular on the flat belt section 15. These forces can result, for example, in a deformation of the flat belt section 15 in a direction toward the second side 19 of the flat belt section 15. The bearing unit 3 is arranged on the second side 19 of the flat belt section 15 and can therefore oppose the deformation of the flat belt section 15 in the direction toward the second side 19 of the flat belt section 15 or even prevent the deformation of the flat belt section 15 in the direction toward the second side 19 of the flat belt section 15.

The bearing unit 3 is designed for the tire test stand 1. The bearing unit 3 comprises a fastening section with which the bearing unit 3 can be attached to a fastening section of the tire test stand 1. In the example embodiment of the tire test stand 1 shown in FIG. 1, the fastening section of the bearing unit 3 can be attached to a fastening section of the frame of the tire test stand 1.

The bearing unit 3 comprises a carrier unit 21 and a coating unit 23. The carrier unit 21 has an inlet section 25 and a plurality of outlet sections. The inlet section 25 defines an inlet opening 27. Each outlet section 29 of the plurality of outlet sections defines an outlet opening 31. In the embodiment of the bearing unit 3 according to the invention represented schematically in FIG. 2, as an example 130 outlet sections and 130 outlet openings are represented schematically. Each outlet opening 31 is connected to the inlet opening 27 in such manner that when a pressurized gaseous fluid flows into the inlet opening 27, the pressurized gaseous fluid flows out of each outlet opening 31. Since each outlet opening 31 is connected to the inlet opening 27 in such manner that when the pressurized gaseous fluid flows into the inlet opening 27 the pressurized gaseous fluid flows out of each outlet opening 31. it is ensured that with the help of the bearing unit 3 a bearing for guiding the belt unit 11 can be provided, in particular since with the help of the gaseous fluid flowing out of each outlet opening 31, on the second side 19 of the flat belt section 15 a force on the second side 19, which acts upon the flat belt section 15 in the direction toward the first side 17 of the flat belt section 15, can be produced. In the carrier unit 21 channels are provided, which connect the inlet opening 27 and the outlet openings to one another so that the pressurized gaseous fluid can flow into the inlet opening 27 and out of every outlet opening 31. The tire test stand 1 comprises a compressor unit which can be connected to the inlet opening 27 and which supplies the pressurized gaseous fluid. In the tire test stand 1 a compressor unit is provided, which delivers air as the gaseous fluid, so that the tire test stand 1 can be constructed particularly simply. Thus, with the help of the bearing unit 3 an air bearing can be provided in the area of the outlet openings for guiding the belt unit 11, such that the bearing unit 3 differs from air bearings known from the prior art, as will be explained in detail later.

The coating unit 23 comprises a plurality of passage sections. Each passage section 33 of the plurality of passage sections defines a passage opening 35. In the embodiment of the bearing unit 3 according to the invention represented schematically in FIG. 2, as an example 130 passage sections and 130 passage openings are shown schematically. The carrier unit 21 and the coating unit 23 are arranged relative to one another in such manner that for each outlet opening 31 the outlet opening 31 concerned and a passage opening 35 associated with the corresponding outlet opening 31 concerned are arranged relative to one another in such a way that when the pressurized gaseous fluid flows out of the outlet opening 31, the gaseous fluid flowing out of the outlet opening 31 flows through the passage opening 35 associated with the outlet opening 31 concerned. Since the carrier unit 21 and the coating unit 23 are arranged relative to one another in such manner that for each outlet opening 31 the outlet opening 31 concerned and a passage opening 35 associated with the outlet opening 31 are arranged relative t one another in such a way that when the pressurized gaseous fluid flows out of the corresponding outlet opening 31 the gaseous fluid flowing out of the corresponding outlet opening 31 flows through the passage opening 35 associated with the outlet opening 31 concerned, it is ensured that the bearing unit can be arranged so that the coating unit 23 can be positioned on a side of the carrier unit 21 that faces toward the flat belt section 15, and with this arrangement, by virtue of the outlet openings, the passage openings and the gaseous fluid and with the help of the coating unit 23 a bearing for guiding the belt unit 11 can be provided. In this case the bearing unit 3 fulfills two functions, so that the bearing unit 3 can also be called a hybrid bearing unit. A first function of the two functions is provided with the help of the outlet openings, the passage openings and the gaseous fluid, in that in the area of the outlet openings and the passage openings a bearing for guiding the belt unit 11 is provided, since with the help of gaseous fluid flowing out of each outlet opening 31, on the second side 19 of the flat belt section 15 a force acting on the flat belt section 15 on the second side 19 can be exerted, which force acts in a direction toward the first side 17 of the flat belt section 15, so that a deformation of the flat belt section 15 in a direction toward the second side 19 of the flat belt section 15 is reduced or even completely prevented. When, now, a load on the flat belt section 15 caused by various load conditions of the tire 5 becomes so severe that the flat belt section 15 is deformed enough to come into contact with the bearing unit 3, then for that contact the coating unit 23 is provided, which independently of the structure of the carrier unit 21 can be designed for contact with the flat belt section 15. A second function of the two functions is provided with the help of the coating unit 23, in that additionally, by virtue of the coating unit 23, a contact surface for the contact with the flat belt section 15 is provided so that on the second side 19 a force additionally acting upon the flat belt section 15 can be provided, which force acts in a direction toward the firs side 17 of the flat belt section 15.

In the embodiment of the bearing unit 3 according to the invention shown schematically in FIG. 2, between the carrier unit 21 and the coating unit 23 there is arranged a plate unit 37, wherein the plate unit 37 and the coating unit 23 are connected to one another. Since a plate unit 37 is arranged between the carrier unit 21 and the coating unit 23 and the plate unit 37 and the coating unit 23 are connected to one another, it is ensured that the plate unit 37 can be replaced together with the coating unit 23, in particular without having to replace or otherwise work on the carrier unit 21. In the embodiment of the bearing unit 3 according to the invention shown schematically in FIG. 2 the plate unit 37 is connected on a first side of the plate unit 37 to the carrier unit 21 and is connected on a second side of the plate unit 37 opposite the first side thereof to the coating unit 23. Now, when the coating unit 23 has to be renewed, the carrier unit 21 and the plate unit 37 can be separated from one another and a new plate unit 37, which is also connected to a coating unit 23, can be connected to the carrier unit 21. Since the plate unit 37 is arranged between the carrier unit 21 and the coating unit 23 and since the plate unit 37 is connected to the coating unit 23, the replacement of the coating unit 23 is greatly simplified. As already described, the plate unit 37 and the coating unit 23 are connected to one another, which in the embodiment of the bearing unit 3 according to the invention shown schematically in FIG. 2 is ensured since the plate unit 37 is coated with the coating unit 23. Thus, the coating unit 23 forms a layer with which the plate unit 37 is coated.

Just like the coating unit 23, so also the plate unit 37 has a plurality of passage sections. Each passage section of the plurality of passage sections is covered in FIG. 2 by a section of the coating unit 23. Each passage section defines a passage opening 39. In the embodiment of the bearing unit 3 according to the invention shown schematically in FIG. 2, as an example 130 passage sections and 130 passage openings are provided. The carrier unit 21, the coating unit 23 and the plate unit 37 are arranged relative to one another in such manner that for every outlet opening 31, the outlet opening 31 concerned, a passage opening 39 of a corresponding passage section of the plate unit 37 associated with the outlet opening 31 and a passage opening 35 of a corresponding passage section 33 of the coating unit 23 associated with the outlet opening 31 are arranged relative to one another in such manner that when the pressurized gaseous fluid flows out of the outlet opening 31 concerned, the gaseous fluid flowing out of the outlet opening 31 flows first through the passage opening 39 of the corresponding passage section of the plate unit 37 and then through the passage opening 35 of the corresponding passage section 33 of the coating unit 23 associated with the outlet opening 31 concerned. Since the carrier unit 21, the coating unit 23 and the plate unit 37 are arranged relative to one another in such a way that for each outlet opening 31 the outlet opening 31, a passage opening 39 of the corresponding passage section of the plate unit 37 associated with the outlet opening 31 concerned and a passage opening 35 of the corresponding passage section 33 of the coating unit 23 associated with the outlet opening 31 are arranged relative to one another in such manner that when the pressurized gaseous fluid flows out of the outlet opening 31 concerned, the gaseous fluid flowing out of the outlet opening 31 flows first through the passage opening 39 of the corresponding passage section of the plate unit 37 and then through the passage opening 35 of the corresponding passage section 33 of the coating unit 23 associated with the outlet opening 31 concerned, it is ensured that the bearing unit 3 can comprise a plate unit 37 and can be arranged so that the coating unit 23 can be positioned on the side of the carrier unit 21 facing toward the flat belt section 15 and with this arrangement, with the help of the outlet openings, the passage openings and the gaseous fluid as well as with the help of the coating unit 23, a bearing for guiding the belt unit 11 can be provided. In this case the bearing unit 3 fulfills the two functions already described and at the same time it can be ensured that the coating unit 23 can be replaced particularly simply. In the embodiment of the bearing unit 3 according to the invention shown schematically in FIG. 2, for each outlet opening 31 a corresponding passage opening 35 of a corresponding passage section 33 of the coating unit 23 and a corresponding passage opening 39 of a corresponding passage section of the plate unit 37 are provided.

In an alternative embodiment of the bearing unit 3 according to the invention, the carrier unit 21 and the coating unit 23 are connected to one another. Since the carrier unit 21 and the coating unit 23 are connected to one another, a particularly simply constructed bearing unit 3 is obtained because, in particular, a plate unit 37 can be omitted. As already described, the carrier unit 21 and the coating unit 23 are connected to one another, which in the alternative embodiment of the bearing unit 3 according to the invention, is ensured in that the carrier unit 21 is coated with the coating unit 23. Thus, the coating unit 23 forms a layer with which the carrier unit 21 is coated.

In the embodiment of the bearing unit 3 according to the invention shown schematically in FIG. 2, the carrier unit 21 is made of a metal alloy, namely steel. Since the carrier unit 21 is made of a metal alloy, a mechanically particularly robust carrier unit 21 is obtained. Since the carrier unit 21 is made of steel, the mechanical robustness of the carrier unit 21 is particularly optimal. In an alternative embodiment of the bearing unit 3 according to the invention the carrier unit 21 is made of metal, namely aluminum. Since the carrier unit 21 is made of aluminum, the carrier unit 21 can be made in a particularly weight-saving manner.

In the embodiment of the bearing unit 3 according to the invention shown schematically in FIG. 2, the coating unit 23 consists of a metal alloy, namely stainless steel, and a polymer, namely a fluorpolymer in the form of polytetrafluorethylene (PTFE). Since the coating unit 23 comprises a metal alloy, namely stainless steel, and a polymer, namely a fluorpolymer in the form of polytetrafluorethylene (PTFE), the coating unit 23 provides a surface for contact with the belt unit 11, in particular the flat belt section 15, such that the surface has a low coefficient of friction along with high abrasion resistance and high temperature resistance.

The bearing unit 3 is arranged on a second side 19 of the flat belt section 15 opposite the first side 17 thereof, in such manner that the coating unit 23 is arranged on a side of the carrier unit 21 facing toward the flat belt section 15. Since the bearing unit 3 is arranged on a second side 19 of the flat belt section 15 opposite the first side 17 in such a way that the coating unit 23 is arranged on a side of the carrier unit 21 facing toward the flat belt section 15, it is ensured that the coating unit 23 is available for contact with the flat belt section 15 and the coating unit 23 protects the carrier unit 21 against contact with the flat belt section 15. Thus, the coating unit 23 can be specifically designed for contact with the flat belt section 15 and if the coating unit 23 undergoes wear, the coating unit 23 can be renewed or replaced and the carrier unit 21 can still be used, whereby a particularly resource-sparing bearing unit 3 and a particularly resource-sparing tire test stand 1 can be obtained.

The belt unit 11 comprises a metal alloy, namely steel, and can also be called a steel band. In particular the belt unit 11 is made of steel. Since the belt unit 11 is made of steel, it is ensured that in various load conditions of the tire 5 the belt unit 11 is deformed only very slightly. Accordingly, with the help of the tire test stand 1 tires 5 can be mechanically loaded particularly severely.

When the flat belt section 15 is not loaded by a tire 5, then the flat belt section 15 extends along a first plane. Even when the tire 5 loads the flat belt section 15 only slightly, the first flat belt section 15 extends along the first plane. If the loading of the first flat belt section 15 by the tire 5 increases further, then the first flat belt section 15 is deformed in a direction toward the second side 19 of the flat belt section 15. As already described, the bearing unit 3 opposes that deformation and thus prevents such a deformation or reduces that deformation, at least in contrast to a situation in which no bearing unit 3 is provided. The coating unit 23 extends along a second plane, which in an assembled condition in which the bearing unit 3 has been fitted into the test stand 1, extends parallel to the first plane. Since the coating unit 23 extends along the second plane, the coating unit 23 provides a particularly flat surface for contact with the flat belt section 15, so that a particularly severe deformation of the flat belt section 15 in a direction toward the bearing unit 3 can be counteracted by virtue of the surface of the coating unit 23, whereas by contact between the flat surface and the flat belt section 15 the flat belt section 15 undergoes only to particularly slight mechanical loading. The plate unit 37 extends along a third plane running parallel to the second plane. Since the plate unit 37 extends along the third plane which runs parallel to the second plane, it is ensured that the plate unit 37 forms a mechanically robust section with which the coating unit 23 is connected and on which the coating unit 23, when it comes into contact with the flat belt section 15, can absorb forces acting upon it due to that contact. The carrier unit 21 extends along a fourth plane running parallel to the third plane and parallel to the second plane. Since the carrier unit 21 extends along a fourth plane running parallel to the third plane and parallel to the second plane, it is ensured that the carrier unit 21 forms a mechanically robust section with which the plate unit 37 is connected and on which the plate unit 37, when the coating unit 23 comes into contact with the flat belt section 15, can absorb forces that act upon the plate unit 37 due to the contact.

As already described, in the embodiment of the bearing unit 3 according to the invention shown schematically in FIG. 2, as an example 130 outlet sections, 130 outlet openings, 130 passage sections and 130 passage openings are represented schematically. The present invention is not limited to these specific numbers. Rather, other numbers too are included in the concept of the invention. For the greater clarification of each outlet section 29, each outlet opening 31, each passage section 33 and each passage opening 35, an enlarged section of FIG. 2 with a dashed-line border is illustrated, in which an outlet section 29, an outlet opening 31, a passage section 33 and a passage opening 36 are shown. The two dashed lines extending in FIG. 2 between the bearing unit 3 and the enlarged representation indicate the position where the example section is located in the bearing unit 3.

As already described, FIG. 3 shows a schematic representation of the embodiment of the method according to the invention for producing the embodiment of the bearing unit 3 according to the invention represented schematically in FIG. 2. In a first process step 101 of the method passage openings are made in the plate unit 37. In a second process step 102 of the method, a surface of the plate unit 37 is roughened by blasting the surface with jets. In a third process step 103 of the method incandescent metal alloy particles, namely incandescent particles of a stainless steel, are sprayed onto the roughened surface of the plate unit 37, which can also be called thermal spraying, and then cooled again in the third process step 103. The sprayed-on and cooled metal alloy particles form a layer with high and low points. Since in the second process step 102 the surface of the plate unit 37 was roughened, it is ensured that a mechanically particularly robust connection can be formed between the layer with high and low points and the surface of the plate unit 37. In a fourth process step 104 of the method, a polymer layer is applied over the sprayed-on metal particles. Since the metal particles form the layer with the high and low points, it is ensured that a mechanically particularly robust connection can be formed between the polymer layer and the sprayed-on metal particles. The polymer layer consists of a fluorpolymer, namely polytetrafluorethylene (PTFE). Since the polymer layer consists of a fluorpolymer, namely polytetrafluorethylene (PTFE), it is ensured that by virtue of the polymer layer a particularly temperature-resistant surface with a low coefficient of friction and high abrasion resistance can be produced. The next thing is that in the fourth step 104 a further polymer layer, also consisting of a fluorpolymer, namely polytetrafluorethylene (PTFE), is formed, or a plurality of further polymer layers, each of which consists of a fluorpolymer, namely polytetrafluorethylene (PTFE), are applied over the polymer layer already covering the sprayed-on metal particles. Thus, with the help of the second process step 102, the third process step 103 and the fourth process step 104, a layer with high and low points is produced on the surface of the plate unit 37 and a number of further polymer layers are applied over that layer. Next, in a fifth process step 105, the passage openings in the layer with high and low points and in the several polymer layers are made, so that the coating unit 23 has been produced. Accordingly, the coating unit 23 comprises the layer with high and low points and the polymer layers, such that the passage openings extend through those layers. In the fifth process step 105 the passage openings are made in such manner that for each outlet opening 31 the outlet opening 31 concerned and a passage opening 35 associated with the outlet opening 31 are arranged relative to one another in such manner that when the pressurized gaseous fluid flows out of the outlet opening 31 concerned, the gaseous fluid flowing out of the outlet opening 31 flows through the passage opening 35 associated with that outlet opening 31.

Thus, with the help of the method the bearing unit 3 can be produced. In the method, the carrier unit 21 and the coating unit 23 are provided in such a way that the carrier unit 21 and the coating unit 23 are arranged relative to one another so that for each outlet opening 31, the outlet opening 31 concerned and a passage opening 35 associated with the outlet opening 31 are arranged relative to one another in such manner that when the pressurized gaseous fluid flows out of the outlet opening 31 concerned, the gaseous fluid flowing out of the outlet opening 31 flows through the passage opening 35 associated with that outlet opening 31. Since the carrier unit 21 and the coating unit 23 are arranged relative to one another in such a way that for each outlet opening 31, the outlet opening 31 concerned and a passage opening 35 associated with the outlet opening 31 are arranged relative to one another so that when the pressurized gaseous fluid flows out of the corresponding outlet opening 31, the gaseous fluid flowing out of the outlet opening 31 concerned flows through the passage opening 35 associated with that outlet opening 31, it is ensured that the bearing unit 3 can be arranged in such manner that the coating unit 23 can be positioned on a side of the carrier unit 21 facing toward the flat belt section 15 and with this arrangement, with the help of the outlet openings, the passage openings and the gaseous fluid and also with the help of the coating unit 23, a bearing for guiding the belt unit 11 can be provided. In this case, the bearing unit 3 fulfills the two functions already described.

Even though the process steps are described in a particular sequence, the present invention is not limited to that sequence. Rather, the individual process steps can be carried out in any rational sequence, in particular also parallel to one another in time, at least in part.

In addition, it should be pointed out that “comprising” does not exclude any other elements or steps, and “one” or “a” does not exclude a plurality. Furthermore, it should be pointed out that features described with reference to one of the above example embodiments can also be used in combination with other features of other example embodiments described above. Indexes in the claims should not be regarded as limitations.

### INDEXES

1 Tire test stand
3 Bearing unit
5 Tire
7 Tread surface
9 Rotation axis
11 Belt unit
13 Deflection roller
15 Flat belt section
17 First side of the flat belt section
19 Second side of the flat belt section
21 Carrier unit
23 Coating unit
25 Inlet section
27 Inlet opening
29 Outlet section
31 Outlet opening
33 Passage section
35 Passage opening of a passage section of the coating unit
37 Plate unit
39 Passage opening of a passage section of the plate unit
101 First process step
102 Second process step
103 Third process step
104 Fourth process step
105 Fifth process step

1-10. (canceled)

11. A bearing unit (3) for a tire test stand (1), comprising:
a carrier unit (21) having an inlet section (25) that defines an inlet opening (27), and a plurality of outlet sections, wherein each outlet section (29) of the plurality of outlet sections defines an outlet opening (31) connected with the inlet opening (27) in such manner that when a pressurized gaseous fluid flows into the inlet opening (27), the pressurized gaseous fluid flows out of each outlet opening (31); and
a coating unit (23) having a plurality of passage sections, such that each passage section (33) of the plurality of passage sections defines a passage opening (35);
wherein the carrier unit (21) is arranged relative to the coating unit (23) so that for each outlet opening (31) the outlet opening (31) concerned and a passage opening (35) associated with the outlet opening (31) are arranged so that when the pressurized gaseous fluid flows out of the outlet opening (31) concerned, the gaseous fluid flowing out of the outlet opening (31) flows through the passage opening (35) associated with that outlet opening (31).

12. The bearing unit (3) according to claim 11, wherein the carrier unit (21) is connected to the coating unit (23).

13. The bearing unit (3) according to claim 11, comprising a plate unit (37) arranged between the carrier unit (21) and the coating unit (23), wherein the plate unit (37) and the coating unit (23) are connected to one another.

14. The bearing unit (3) according to claim 11, wherein the carrier unit (21) comprises a metal or a metal alloy.

15. The bearing unit according to claim 11, wherein the coating unit (23) comprises a metal or a metal alloy.

16. The bearing unit (3) according to claim 11, wherein the coating unit comprises a polymer.

17. A method of making the bearing unit of claim 11, comprising:
preparing the carrier unit (21) and the coating unit (23) in such manner that the carrier unit (21) and the coating unit (23) are arranged relative to one another in such a way that for each outlet opening (31) the outlet opening (31) concerned and a passage opening (35) associated with that outlet opening (31) are arranged relative to one another in such manner that when the pressurized gaseous fluid flows out of the corresponding outlet opening (31) concerned, the gaseous fluid flowing out of the outlet opening (31) flows through the passage opening (35) associated with that outlet opening (31).

18. The method according to claim 17, wherein a surface of the carrier unit (21) or a surface of the plate unit (37) is roughened, in such manner that metal particles or metal alloy particles are sprayed onto the roughened surface of the carrier unit (21) or onto the roughened surface of the plate unit (37), and a polymer is applied over the sprayed-on metal particles.

19. A tire test stand (1)
a frame;
a tire holder attached to the frame, on which a tire (5) with a tread surface (7) can be fitted so as to rotate about its rotation axis (9);
a belt unit (11);
two deflection rollers mounted to rotate relative to the frame, wherein the deflection rollers are partially wrapped-around by the belt unit (11), so that the belt unit (11) forms a flat belt section (15) between the deflection rollers;
wherein, when the tire (5) is fitted rotatably onto the tire holder, the tire (5) can be brought on a first side (17) of the flat belt section (15) to a contact position in which the tread surface (7) of the tire (5) and the flat belt section (15) are in contact;
wherein, when the tire (5) and the flat belt section (15) are in contact and the belt unit (11) is moved relative to the tire (5), the tire (5) rolls on the flat belt section

(15) and
the bearing unit (3) according to claim 11 arranged on a second side (19) of the flat belt section (15) opposite the first side (17) in such manner that the coating unit (23) is arranged on a side of the carrier unit (21) that faces toward the flat belt section (15).

20. The test stand (1) according to claim 19, wherein the belt unit (11) comprises a metal or a metal alloy.
